(19) United States
(12) Patent Application Publication
(10) Pub. No.: US 2015/0321443 A1
(43) Pub. Date: Nov. 12, 2015

(54) SANDWICH PANEL, CONTAINER MADE OF SUCH A SANDWICH PANEL AND METHOD OF MANUFACTURING THE SAME

(71) Applicant: EMBALLAGES CRE-O-PACK CANADA INC., Mont-Royal (CA)

(72) Inventors: Jean-Sébastien COMTOIS, Sainte-Therese (CA); Michel MONETTE, Napierville (CA)

(21) Appl. No.: 14/705,531

(22) Filed: May 6, 2015

Related U.S. Application Data
(60) Provisional application No. 61/989,144, filed on May 6, 2014.

(51) Int. Cl. B32B 3/12; B32B 5/02; B65D 43/02; B32B 27/32

(52) U.S. Cl. CPC B32B 3/12; B32B 27/32; B32B 5/02; B65D 43/0202; B32B 2262/101; B32B 2439/62; B65D 2543/00296; B65D 2543/00314

(57) ABSTRACT

A sandwich panel including a core and a first skin layer and a second skin layer on opposite sides of the core, wherein one of the skin layers extends beyond the core along an edge of the sandwich panel by a protruding portion, the protruding portion comprising a bent portion bent towards the core. The bent portion defines an open edge space sized to receive a marginal edge region of an adjacent sandwich panel, or is bent and folded over an exposed edge of the core. A container including a plurality and combination of the above-mentioned sandwich panels with different bent portions is also provided. A method for manufacturing such sandwich panels and containers is also disclosed. The method includes applying a linear source of heat to the protruding portions of the sandwich panels. A method for assembling the sandwich panels into a container body is also provided.

### CROSS-REFERENCE TO RELATED APPLICATIONS

This application claims priority under 35 USC §119(e) of U.S. provisional patent application 61/989,144 filed on May 6, 2014, the specification of which is hereby incorporated by reference in its entirety.

### FIELD OF THE INVENTION

The present invention generally relates to sandwich panels and more particularly to an improved assembly of a container made of sandwich panels, as well as a method of manufacturing such sandwich panels and containers.

### BACKGROUND

There are a number of transport containers that are displaceable by individuals and that are used to transport a variety of items including hardware, electrical/electronic equipment and the like.

Certain transport containers are also provided with rim structures or seals to cover any exposed seams or corners of the container in order to reduce any external element infiltration, including water or humidity among others. These structures or seals add to the overall weight of the container.

However, since these containers have to be transported from one location to another, any possible weight savings in the manufacturing of the containers can result in significant reductions in transportation costs.

Therefore, there is a need for an improved container that can offer such weight savings, while presenting an assembled substantially sealed structure to preserve the interior of the container from element infiltration. Sandwich panels with honeycomb cores offer a partial solution to such a problem in terms of offering a material for the container that has a high resistance over weight ratio while being substantially water-resistant.

A container made of composite sandwich panels is disclosed, for example, in CN 201254361. While having a high resistance over weight ratio due to the use of composite sandwich panels, such a container may be sensible to humidity and water damages. Indeed, the interface between the skin layers and the core of each sandwich panel may be exposed to water or humid air and this exposition may cause the core to detach from the skin layer despite the glue used to bond them together. Therefore, there is a need to provide an improved container made of composite sandwich panels that would prevent exposition to harmful environments of the interface between the skin layers and the core of each sandwich panel.

In addition, prior art sandwich panels have typically shown a low resistance to lateral loads. Therefore, there is also a need for an improved sandwich panel for use in the assembly of transport containers or other structures that require improved performance characteristics.

### SUMMARY

It is therefore a general object to provide an improved sandwich panel that addresses at least one of the above-mentioned needs.

It is another object to provide an improved container that addresses at least one of the above-mentioned needs.

It is another object to provide methods of manufacturing the above-mentioned sandwich panels and containers.

In accordance with a first aspect, there is provided a sandwich panel including a geometrical pattern structure core defining hollow cells, and a first layer and a second skin layer extending on opposite sides of the core. One of the first and second skin layers has at least one protruding portion extending beyond the core along at least one edge of the sandwich panel. At least one of the protruding portion comprises a bent portion bent towards the core.

In an embodiment, the bent portion of at least one of the at least one protruding portion is spaced-apart from a respective edge of the core to define an open edge space therebetween, the open edge space having a width substantially corresponding to a thickness of the sandwich panel.

In some implementations, the bent portion of at least one of the at least one protruding portion is folded against and over a respective edge of the core and covers the same.

In some implementations, the geometrical pattern structure core is made of polypropylene and wherein the first and second skin layers comprise at least one of fiberglass and polypropylene.

In an embodiment, a container comprising a plurality of sandwich panels as defined above and assembled together by inserting a marginal edge region of a respective one of the sandwich panels in the open edge space of an adjacent one of the sandwich panels.

In accordance with another aspect, there is provided a container comprising a container body including a plurality of sandwich panels assembled together to define a storage space. The plurality of sandwich panels comprising a geometrical pattern structure core defining hollow cells, and a first layer and a second skin layer extending on opposite sides of the core. The plurality of sandwich panels comprising front and rear sandwich panels, first and second side sandwich panels, and a bottom sandwich panel. A plurality of the front and rear sandwich panels and the first and the second side sandwich panels comprising at least one protruding portion defined by one of the first and second skin layers extending beyond the core along a respective side edge and including a bent portion bent towards the core and spaced-apart from the respective edge of the core to define an open edge space therebetween, with a marginal edge region of an adjacent one of the front, rear, first side and second side sandwich panels being inserted in the open edge space to engage together the two adjacent ones of the sandwich panels; and for each adjacent edges of the bottom sandwich panel with a respective one of the front, rear, first side and second side sandwich panels, one of the bottom sandwich panel and the respective one of the front, rear, first side and second side sandwich panels comprising at least one protruding portion defined by one of the first and second skin layers extending beyond the core along a respective edge and including a bent portion bent towards the core and spaced-apart from the respective edge of the core to define an open edge space therebetween, with a marginal edge region of the other one of the bottom sandwich panel and the respective one of the front, rear, first side and second side sandwich panels being inserted in the open edge space to engage together the two adjacent ones of the sandwich panels.

In an embodiment, top edges of the front, rear, first side and second side sandwich panels comprise a protruding portion defined by one of the first and second skin layers extending beyond the core along a respective top edge and including a bent portion folded against and over the respective top edge of the core and covering the same.

In an embodiment, the side edges of the first side and second side sandwich panels comprise the protruding portions defining the open edge spaces, and a bottom edge of each of the front, rear, first side and second side sandwich panels comprise the protruding portions defining the open edge spaces.

In an embodiment, in the container body, the geometrical pattern structure core of the plurality of sandwich panels defining the container body is unexposed and the container body further comprises fasteners extending through the bent portions of the sandwich panels and the marginal edge region of the adjacent one of the sandwich panels inserted in a respective one of the open edge spaces for fastening the assembled sandwich panels together.

In some implementations, the container as defined above further comprises a top cover engageable with the container body and configurable in a closed configuration for preventing access to the storage space. The top cover comprises a cover sandwich panel including a geometrical pattern structure core defining hollow cells, and an outer skin layer and an inner skin layer extending on opposite sides of the core, the cover sandwich panel comprising: a top panel section, two opposed side panel sections, a front panel section, and a rear panel section, the top cover comprising folding channels defined between the core of the top panel section and the core of the respective one of the side, front, and rear panel sections, each one of the side, front, and rear panel sections being hingedly connected to the top panel section through the outer skin layer, the geometrical pattern structure core and the inner skin layer extending discontinuously along the top cover, and the side, front, and rear panel sections extending substantially perpendicular to the top panel section in an assembled configuration of the top cover. The folding channels are free of the geometrical pattern structure core and the inner skin layer and a width of the folding channels substantially correspond to a thickness of the cover sandwich panel.

In an embodiment, sections of the outer skin layer extending in the folding channels are juxtaposed to a respective one of the edges of the core of the top panel section and cover the same in the assembled configuration of the top cover. Each one of the side, front, and rear panel sections of the top cover comprises a protruding portion defined by the outer skin layer extending beyond the core along a respective edge extending substantially parallel to the respective one of the folding channel. Each one of the protruding portion includes a bent portion folded against and over the respective edge of the core and covering the same. The front and rear panel sections extend along a width of the top panel section and the two side panel sections extend along a length of the top panel section. The core and the inner skin layer of one of the front and rear panel sections and the two side panel sections are shorter than a corresponding one of the width and the length of the top panel section along which the respective one of the panel sections extend, thereby defining side protruding portions of the outer skin layer. The outer skin layer in the front and rear panel sections has substantially a same width than the width of the top panel section. The outer skin layer in the two side panel sections has substantially a same length than the length of the top panel section. The side protruding portions are folded against the adjacent one of the other one of the front and rear panel sections and the two side panel sections, against the outer skin layer thereof, in the assembled configuration of the top cover.

In an embodiment, the geometrical pattern structure core is made of polypropylene and the skin layers comprise at least one of fiberglass and polypropylene.

In accordance with yet another aspect, there is provided a method for manufacturing a sandwich panel, comprising providing a sandwich panel comprising a geometrical pattern structure core defining hollow cells, and a first skin layer and a second skin layer on opposite sides of the core. The next step involves machining at least one edge of the sandwich panel to define a protruding portion including one of the first and second skin layers extending beyond the core along said at least one edge of the sandwich panel. The last step involves bending at least a section of the protruding portion towards the core, thus forming a bent portion.

In an embodiment, the step of bending at least a section of the protruding portion comprises bending at least a section of the protruding portion along a bending axis spaced-apart from the core to define an open edge space between the bent portion and an edge of the core. The open edge space has a width substantially corresponding to a thickness of the sandwich panel.

In an embodiment, the step of bending at least a section of the protruding portion comprises bending at least a section of the protruding portion along a bending axis adjacent to an edge of the core. The bent portion is folded against and extending over the edge of the core and covers the same.

In an embodiment, the step of machining at least one of the edges of the sandwich panel comprises successively cutting a plurality of thin layers of the other one of the skin layers and the core to expose the skin layer including the protruding portion. The step of machining at least one of the edges of the sandwich panel further comprises cutting a slit into the other one of the skin layers and the core and pulling off a section including the other one of the skin layers and the core and from the skin layer including the protruding portion.

In accordance with yet another aspect, there is provided a method for assembling a container body, comprising manufacturing a plurality of sandwich panels in accordance with the above. The next step involves assembling the plurality of sandwich panels together by inserting a marginal edge region of a respective one of the sandwich panel in the open edge space of an adjacent one of the sandwich panel to define the container body having a front sandwich panel, a rear sandwich panel, two side sandwich panels spaced-apart from one another, and a bottom sandwich panel. The bottom sandwich panel has edges engaged with each one of the front, rear, and side sandwich panels and each of the front and the rear sandwich panels having side edges engaged with the two side sandwich panels, thereby defining a storage space therebetween. The last step involves securing the assembled sandwich panels together.

In an embodiment, the method further comprises machining top edges of the front, rear, and side sandwich panels to define a protruding portion including one of the skin layers extending beyond the core of the respective one of the top edges of the sandwich panel, and bending at least a section of the protruding portion along a bending axis adjacent to a respective edge of the core. The bent portion is folded against and extending over the edge of the core and covers the same.

In some implementations, the side edges of the side sandwich panels comprise the protruding portions defining the open edge spaces. A bottom edge of each of the front, rear, and side sandwich panels comprise the protruding portions defining the open edge spaces. The step of assembling the plurality of sandwich panels together comprises inserting marginal edge regions of the bottom sandwich panel in a respective one of the open edge spaces defined at the bottom edges of the front, rear, and side sandwich panels and inserting marginal edge regions of front and rear sandwich panels in the open edge spaces defined at the side edges of the side sandwich panels.

In some implementations, the method described above further comprises inserting fasteners through the bent portions of the sandwich panels and marginal edge region of the adjacent one of the sandwich panels inserted in a respective one of the open edge spaces for fastening the assembled sandwich panels together.

Some objects, advantages and other features will become more apparent upon reading the following non-restrictive description of certain optional configurations, given for the purpose of exemplification only, with reference to the accompanying drawings.

### BRIEF DESCRIPTION OF THE FIGURES

Further aspects and advantages of embodiments will become better understood with reference to the description in association with the following Figures, in which similar references used in different Figures denote similar components.

FIG. 1 is a perspective view of a container having a top cover and hardware parts, in accordance with an embodiment.

FIGS. 2A and 2B are respectively exploded perspective and detailed exploded view of the container shown in FIG. 1, with the top cover and hardware parts omitted.

FIGS. 3A and 3B are respectively side exploded view and detailed exploded view of the container shown in FIG. 1, with the top cover and hardware parts omitted.

FIGS. 4A and 4B are schematic views illustrating assembled sandwich panels partially defining the container shown in FIG. 1, with the top cover and hardware parts omitted.

FIGS. 5A and 5B are respectively top exploded and detailed views of the container shown in FIG. 1, with the top cover and hardware parts omitted.

FIGS. 6A and 6B are respectively top and detailed views of the container shown in FIG. 1, with the top cover and hardware parts omitted.

FIGS. 7A and 7B are perspective views illustrating assembly of the top cover shown in FIG. 1, with the hardware parts omitted, in accordance with an embodiment.

FIG. 8 is a top perspective view of a sandwich panel in accordance with an embodiment, wherein two protruding portions extend along both longitudinal sides of the sandwich panel.

FIG. 9 is a top perspective view of a sandwich panel in accordance with another embodiment, wherein protruding portions extend along both longitudinal and lateral sides of the sandwich panel.

FIG. 10 is a top perspective view of a sandwich panel in accordance with another embodiment, wherein two protruding portions having different widths extend along both longitudinal sides of the sandwich panel.

FIGS. 11 and 12 are respectively right and left-side perspective views, fragmented, of assembled sandwich panels in accordance with another embodiment, after bending of the protruding portions.

FIG. 13 is a perspective view, fragmented, of assembled sandwich panels fastened together with rivets, in accordance with an embodiment.

FIG. 14 is a perspective view of an apparatus used for bending a protruding portion on a sandwich panel, in accordance with an embodiment.

FIGS. 15A and 15B are flowcharts of a method for manufacturing a sandwich panel, in accordance with an embodiment.

FIG. 16 is a flowchart of a method for manufacturing and assembling a container body with a plurality of sandwich panels obtained with the method shown in FIGS. 15A and 15B, in accordance with an embodiment.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

In addition, although the optional configurations as illustrated in the accompanying drawings comprise various components and although the optional configurations of the sandwich panel and container as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations, may be used for the sandwich panel and container, and corresponding parts, as briefly explained and as can be easily inferred herefrom, without departing from the scope of the disclosure.

Moreover, although the present description describes the use of a sandwich panel in the assembly of a transport container, the sandwich panel can also be used in several other applications or structures that require similar constituting components, such as cases, boxes or cabinets, among others.

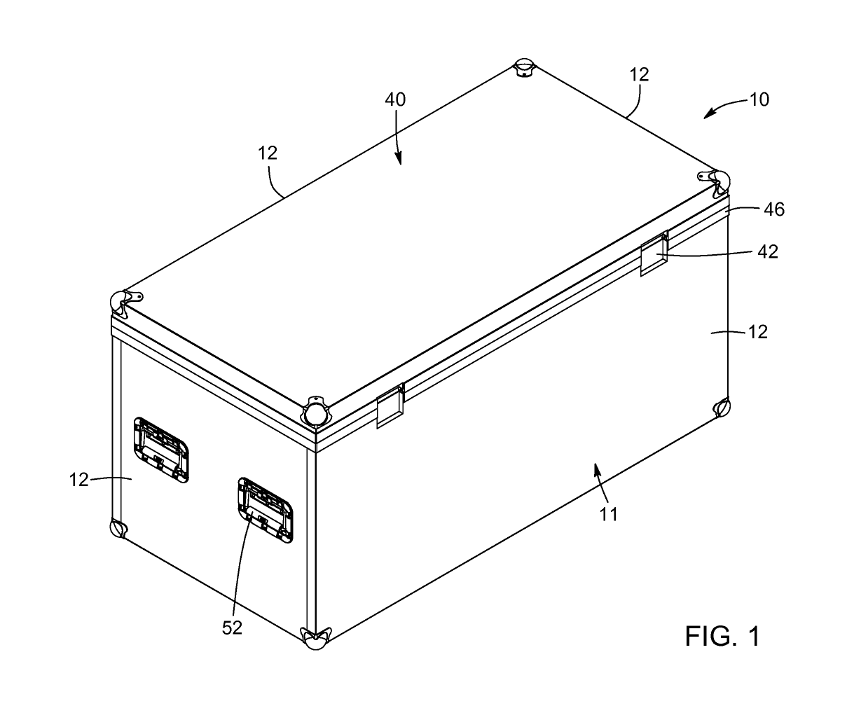

Referring to FIG. 1 and according to a first embodiment, there is shown a container 10 made of a plurality of sandwich panels 12. The container 10 includes an open container body 11 defining a storage space, a top cover 40 engageable with the container body 11 to prevent access to the storage space, and hardware parts. The assembly of sandwich panels 12 to obtain the container body 11 and details about the top cover 40 and some of the other hardware parts shown in FIG. 1 will be provided further below.

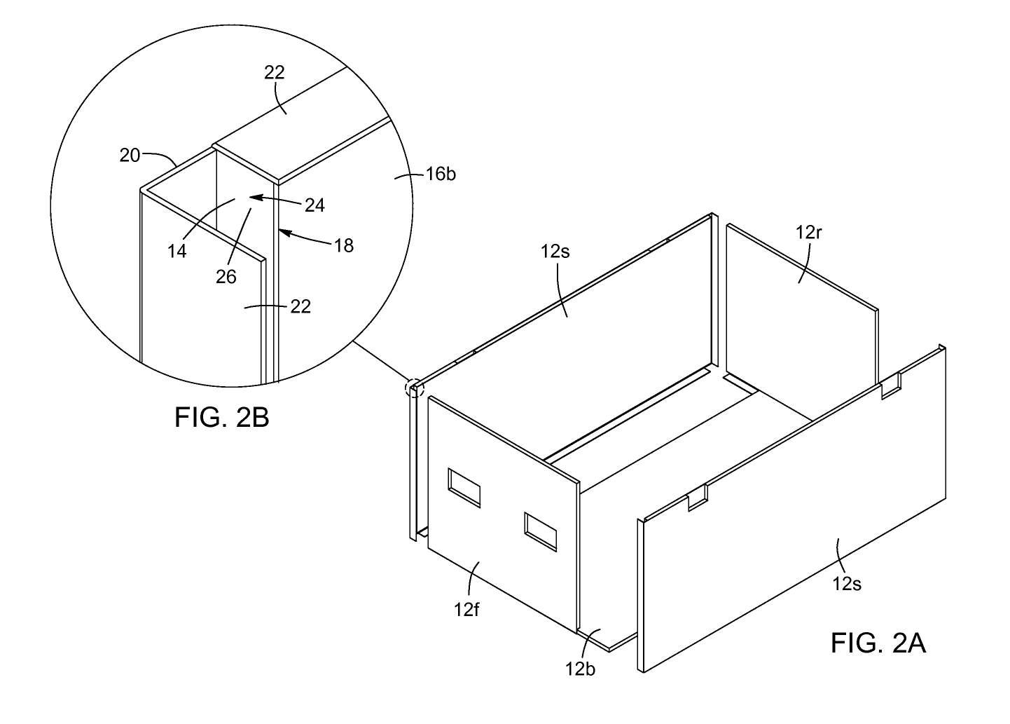

Referring to FIGS. 2A to 5B, there is shown sandwich panels 12 placed in relation to each other in order to, at least partially, form the container body 11. Referring to FIG. 2A, there can be seen five different sandwich panels partially defining the container body 11, namely a front sandwich panel 12f, a rear sandwich panel 12r, two side sandwich panels 12s, and a bottom sandwich panel 12b.

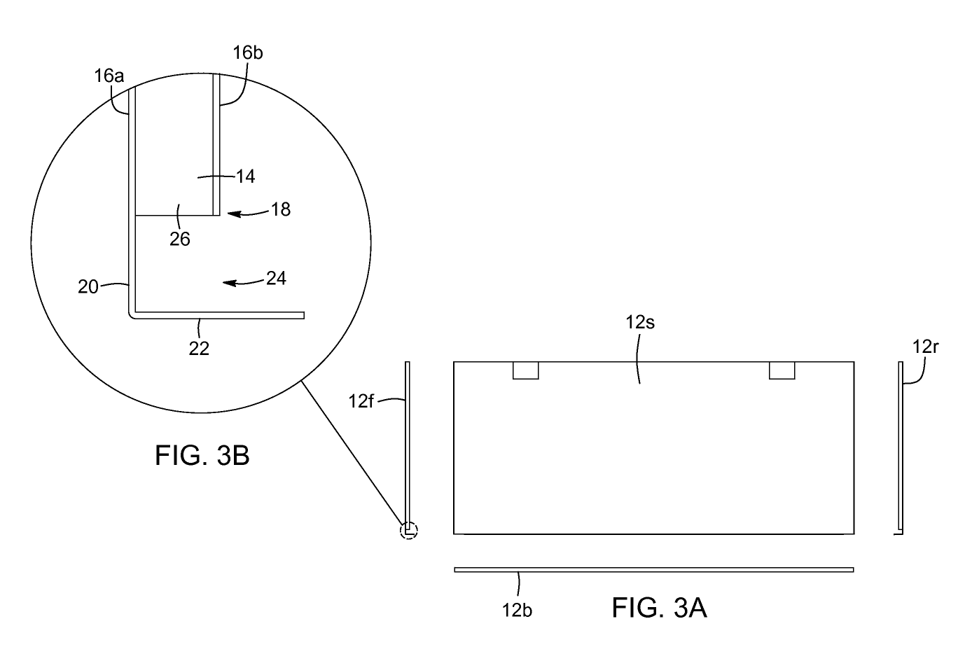

Now referring to FIGS. 2B and 3B, each sandwich panel 12 includes a geometrical pattern structure core 14 defining hollow cells and first and second skin layers 16a, 16b extending on opposite sides of the core 14. The core 14 is a honeycomb type structure with two substantially planar faces. In a particular embodiment, the honeycomb type material is a grid of hexagonal cells. As it will be easily understood by one skilled in the art, any other lattice structure and/or geometrically patterned structure which provide enhanced strength for supporting and protecting loads and create an air space as a result of that structure can be used. In some implementations, the geometrical pattern structure core 14 is made of polypropylene.

In some implementations, the first and second skin layers 16a, 16b include at least one of fiberglass and polypropylene. However, other materials offering similar performance characteristics, such as water resistance, lightweight and puncture resistance amongst others, can be used for both the core 14 and the skin layers 16a, 16b. In an embodiment, the sandwich panels 12 include a reinforced thermoplastic composite skin fused to the faces of a honeycomb polypropylene core. In some applications, the sandwich panels 12 have an overall thickness ranging between about 12 mm (½″) to about 100 mm (4″). The skin thickness can vary between about 0.5 mm (0.02″) to about 2 mm ( 5/64″). In an embodiment, ASC-Honeycomb Sandwich Panels manufactured by AS Composite inc. are used. It is to be noted that every other suitable honeycomb sandwich panels can be used for making the present container body 11 and top cover 40. In the embodiment shown, the skin layers 16a, 16b cover entirely and continuously the planar surfaces of the core 14.

As better seen in FIGS. 2B, 3B and 4A, on some of the sandwich panels 12, one of the first and second skin layers 16a, 16b has at least one protruding portion 20 extending beyond the core 14 at at least one edge of the sandwich panel 12. In the embodiment shown, the protruding portion 20 includes a bent portion 22 bent towards the core 14, i.e. in the direction of the core 14 and the other one of the skin layers 16a, 16b. The bent portion 22 defines an angle smaller than 180° with a remaining section of the skin layer from which it extends. In the embodiment shown, the front sandwich panel 12f, the rear sandwich panel 12r, and the two side sandwich panels 12s each includes at least one protruding portion 20 including a bent portion 22, bent towards the core 14.

Referring to FIGS. 2A to 3B, some of the bent portions 22 of the protruding portions 20 are spaced-apart from a respective edge 26 of the core 14 to define an open edge space 24 therebetween. The open edge space 24 can have a width substantially corresponding to a thickness of the sandwich panel 12. The width of the open edge space 24 extends between the bent portion 22 and an exposed edge 26 of the core 14. The open edge space 24 can also be sized to receive an adjacent sandwich panel 12, as will be described further below.

The bent portion 22 can be bent at 90° or at any suitable angle to receive an adjacent sandwich panel 12. In an embodiment, the bent portion 22 extends substantially parallel to an exposed edge 26 of the core 14. In the embodiment shown, the bent portion 22 is longer than a thickness of the sandwich panel 12, and extends past the other one of the skins 16a, 16b. In alternative embodiments, the length of the bent portion 22 can vary from the embodiment shown. For instance, it can be shorter than or substantially the same length than a thickness of the sandwich panel 12.

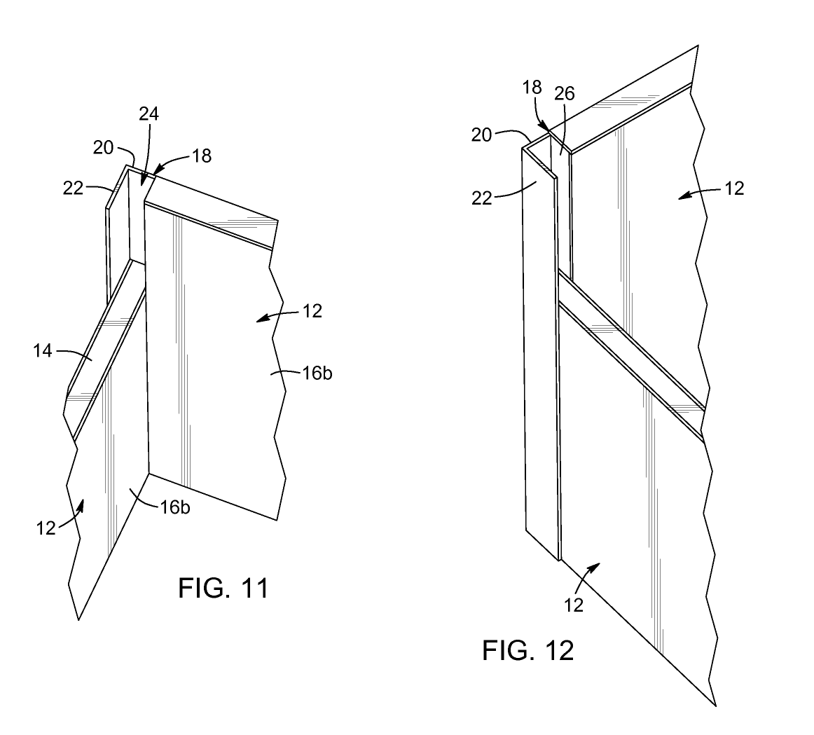

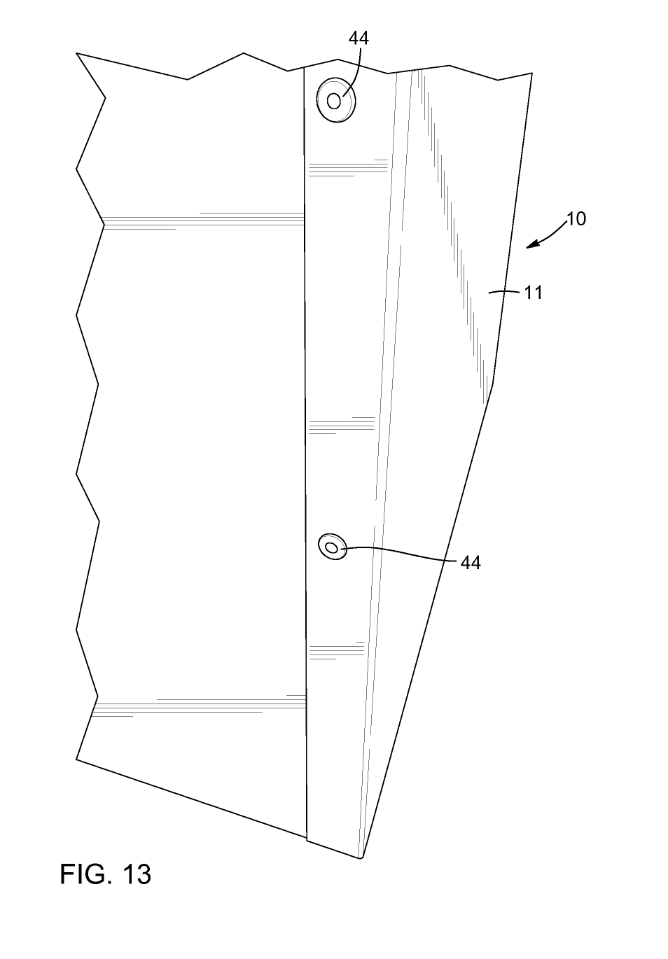

In addition and as better shown in FIGS. 2B, 11 and 12, the bent portion 22 of one or more of the protruding portions 20 can be folded against and over a respective edge 18 of the core 14 and covers the same. In the embodiment shown, a length of the bent portion 22 folded against the respective edge 18 of the core 14 substantially corresponds to a thickness of the sandwich panel 12. In an alternative embodiment, it can either be longer or shorter than the thickness of the sandwich panel 12.

When bent to define an open edge space 24, the bent portion 22 can hence shelter an exposed edge 26 of the core 14 of an adjacent sandwich panel 12 having one of its marginal edge region inserted in the open edge space 24. When bent against the edge 26 of the core 14, the bent portion 22 shelters the edge 26 of the core 14 of the sandwich panel 12. Because the core 14 is made of a geometrical pattern structure defining hollow cells, it may be suitable to be protected against harmful environments or unexposed to external elements.

Therefore, the container 10 includes the following components: first, a container body 11 including a plurality of sandwich panels 12 assembled together to define a storage space. The plurality of sandwich panels 12 include a geometrical pattern structure core 14 defining hollow cells, and first and second skin layers 16a, 16b extending on opposite sides of the core 14. The plurality of sandwich panels 12 include the front and rear sandwich panels 12f, 12r, first and second side sandwich panels 12s, and a bottom sandwich panel 12b. In addition, the plurality of the front and rear sandwich panels 12f, 12r and the first and the second side sandwich panels 12s include at least one protruding portion 20 defined by one of the first and second skin layers 16a, 16b extending beyond the core 14 along a respective side edge. The protruding portion 20 includes a bent portion 22 bent towards the core 14. The bent portion 22 is spaced-apart from the respective edge of the core 14 to define an open edge space 24 therebetween. A marginal edge region of an adjacent one of the front, rear, first side and second side sandwich panels 12f, 12r, 12s is inserted in the open edge space 24 to engage together the two adjacent ones of the sandwich panels 12. In addition, for each adjacent edges of the bottom sandwich panel 12b with a respective one of the front, rear, first side and second side sandwich panels 12f, 12r, 12s, one of the bottom sandwich panel 12b and the respective one of the front, rear, first side and second side sandwich panels 12f, 12r, 12s, includes at least one protruding portion 20 defined by one of the first and second skin layers 16a, 16b extending beyond the core 14 along a respective edge. Once again, each one of the protruding portions 20 includes a bent portion 22 bent towards the core 14 and spaced-apart from the respective edge of the core 14 to define an open edge space 24 therebetween. A marginal edge region of the other one of the bottom sandwich panel 12b and the respective one of the front, rear, first side and second side sandwich panels 12f, 12r, 12s is inserted in the open edge space 24. The open edge space 24 is configured to engage together the two adjacent ones of the sandwich panels 12.

In an embodiment, the skin layer 16a, 16b extending outwardly of the container body 11 includes the protruding portions 20.

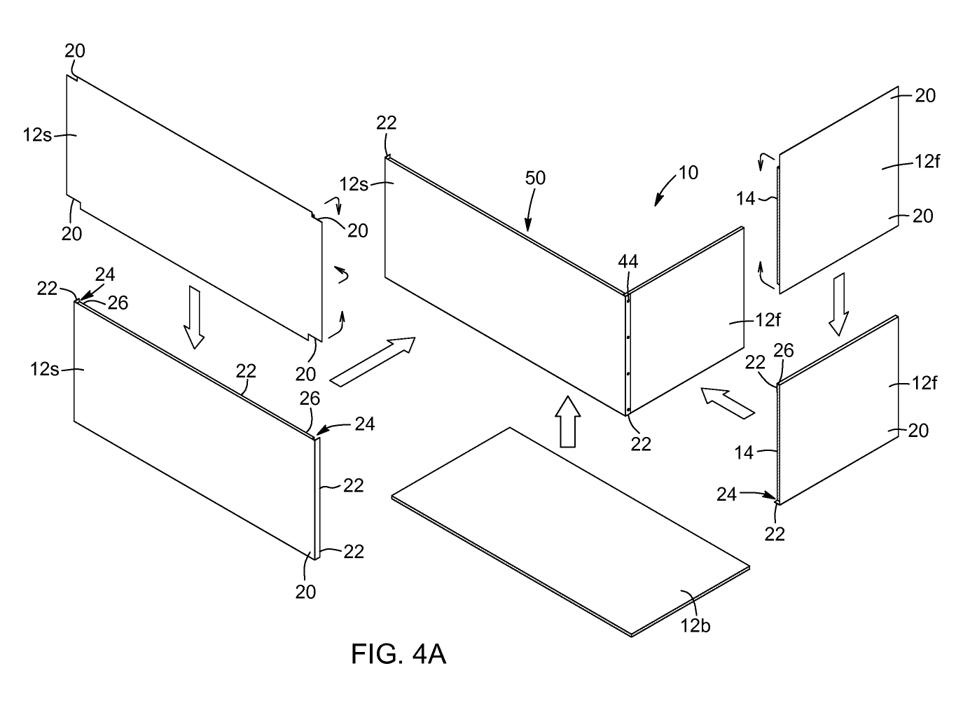

Now referring to FIGS. 4A and 4B, there is shown a partial assembly of the container body 11 using a combination of a plurality of sandwich panels 12 defining assembled sandwich panels 50 and partially defining the container body 11. The sandwich panels 12 are assembled together, as described above, by inserting a marginal edge region of a respective one of the sandwich panels 12 in the open edge space 24 of an adjacent one of the sandwich panels 12. The combination of sandwich panels 12 to be assembled into the container body 11 includes:
the front and the rear sandwich panels 12f, 12r including protruding portions 20 along a top and at a bottom edge thereof;
the first and the second side sandwich panels 12s including protruding portions 20 along front and rear side edges, along a top edge, and along a bottom edge thereof; and
the bottom sandwich panel 12b, being free of protruding portions 20.

Referring to FIG. 4A, the first side sandwich panel 12s, the bottom sandwich panel 12b and the front sandwich panel 12f are shown. In FIG. 4B, the second side sandwich panel 12s, the bottom sandwich panel 12b and the rear sandwich panel 12r are shown. On each figure, thin arrows show how the protruding portions 20 extending along the edges of the plurality of sandwich panels 12 are to be bent while large arrows show the different steps required for assembling the sandwich panels 12 together into assembled sandwich panels 50 and partially defining the container body 11. The assembled sandwich panels 50 even include fasteners 44 to secure the sandwich panels together in the assembled configuration, which will be described further below.

Still referring to FIGS. 4A and 4B, in the embodiment shown, protruding portions 20 at the bottom edges of the front, rear and side sandwich panels 12f, 12r, 12s include bent portions 22 defining open edge spaces 24 sized to receive the marginal edge regions of the bottom sandwich panel 12b. In addition, the top edges of the front, rear, first side and second side sandwich panels 12f, 12r, 12s include a protruding portion 20 defined by one of the first and second skin layers 16a, 16b extending beyond the core 14 along a respective top edge and include a bent portion 22 folded against and over the respective top edge of the core 14 and covering the same, thereby preventing infiltrations therein. Finally, protruding portions 20 on the front and rear side edges of the side sandwich panels 12s include bent portions 22 defining open edge spaces 24 sized to receive marginal edge regions of the front and rear sandwich panels 12f, 12r respectively. Thus, the side edges of the first side and second side sandwich panels 12s include the protruding portions 20 defining open edge spaces 24 and a bottom edge of each of the front, rear, first side and second side sandwich panels 12f, 12r, 12s also include the protruding portions 20 defining the open edge spaces 24 to receive a respective marginal edge region of the bottom sandwich panel 12b.

It is to be understood that, in an embodiment, in the marginal edge regions of at least one of the bottom, front, rear, first side and second side sandwich panels 12b, 12f, 12r, 12s, inserted in a respective one of the open edge spaces 24, one of the first and second skin layers 16a, 16b of the sandwich panels 12 can also include a protruding portion 20 extending beyond the core 14 along the respective edge of the sandwich panels 12. The protruding portion 20 can include a bent portion 22 folded against and over the respective edge of the core 14 and covering the same, thereby preventing infiltrations therein. Therefore, in another embodiment (not illustrated), the side edges of the front and rear sandwich panels 12f, 12r can also include protruding portions 20 with bent portions 22 folded against the respective one of the cores 14. Similarly, in an alternative embodiment, edges of the bottom sandwich panel 12b can include protruding portions 20 with bent portions 22 folded against the core 14.

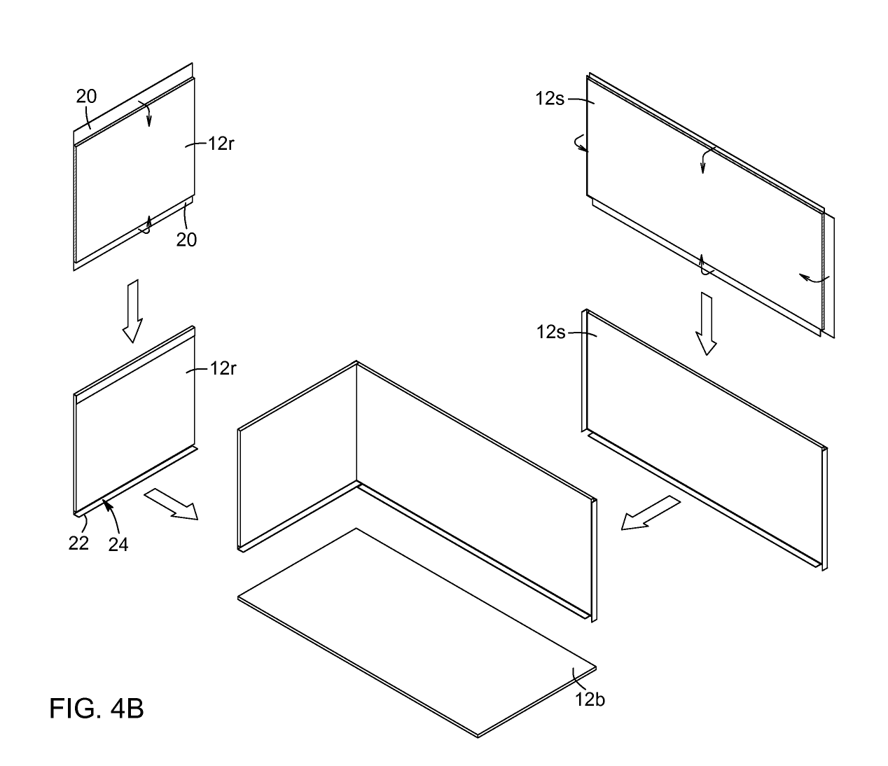

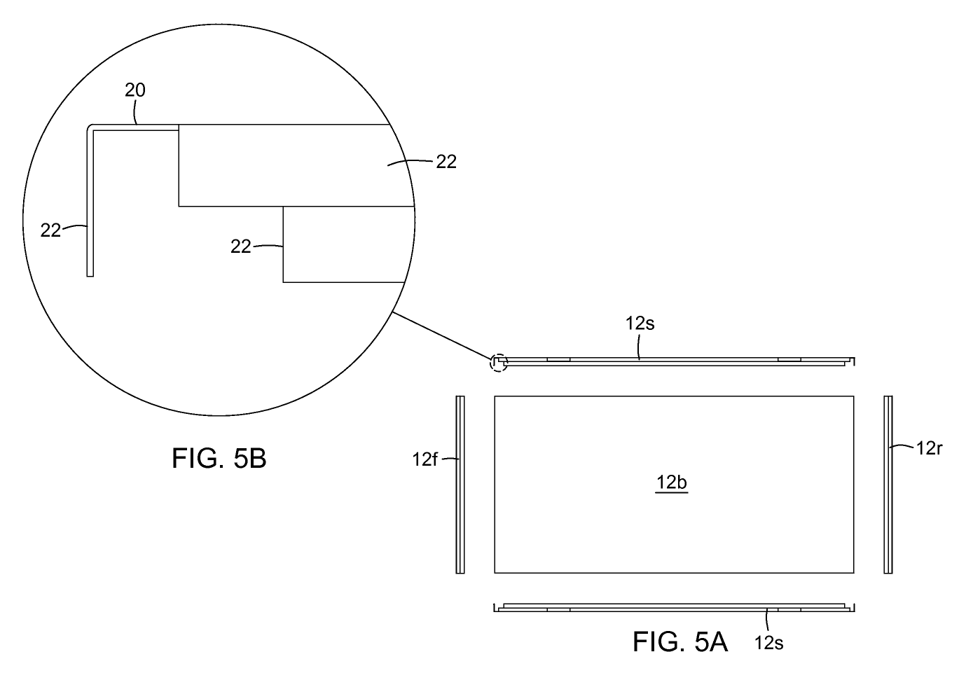

Now referring to the configuration shown in FIGS. 5A to 6B, which is the same embodiment as shown in FIGS. 4A and 4B, this configuration illustrates that, at each edge of the container body 11 to be formed, two sandwich panels 12 are configured in an adjacent configuration. At least one of the two sandwich panels 12 has a folded bent portion 22 defining an open edge space 24 in which the marginal edge region of the other one of the sandwich panels 12 is inserted, thus ensuring that all exposed edges 26 of the core 14 of the two sandwich panels 12 meeting at one edge or corner are sheltered by the bent portion 22. For example, FIG. 5B illustrates that, at the corner represented in the detailed view, the side sandwich panel 12s has a first bent portion 22 partially capping the top exposed edge 26 of the core 14 of the respective side sandwich panel 12s, a second bent portion 22 located at the side edge of the respective side sandwich panel 12s and bent at 90° thereby defining an open edge space 24 for receiving the side edge of the front sandwich panel 12f, and a third bent portion 22 located along the bottom edge of the side sandwich panel 12s and defining an open edge space 24 for receiving the bottom sandwich panel 12b and sheltering a marginal edge portion of the bottom face of the bottom sandwich panel 12b. The assembly represented in FIG. 6B illustrates that, at the corner shown in details, the front sandwich panel 12f has one bent portion 22 capping the top exposed edge 26 of the core 14 of the front sandwich panel 12f, and another bent portion (not illustrated) located along the bottom edge of the respective front sandwich panel 12f and defining an open edge space (not illustrated) for receiving the bottom sandwich panel 12b and sheltering a marginal edge portion of the bottom face of the bottom sandwich panel 12b. The side sandwich panel 12s has the three bent portions 22 as described above. Therefore, in the embodiment illustrated in FIGS. 6A and 6B, if the container body 11 is exposed to water, water infiltration cannot to the core 14 of any sandwich panel 12 of the container body 11 is substantially prevented since the exposed edges 26 of the core 14 of each sandwich panel 12 are sheltered by one bent portion 22 of the respective sandwich panel 12 or by a bent portion 22 of an adjacent sandwich panel 12. Thus, in the container body 11, the geometrical pattern structure core 14 of the plurality of sandwich panels 12 defining the container body 11 is substantially unexposed.

In an alternative embodiment (not illustrated), the container body 11 can be made of made of front, rear and side sandwich panels 12f, 12r, 12s having a bent portion 22 along the bottom edges of the front, rear and side sandwich panels 12f, 12r, 12s defining open edge spaces 24 sized to receive the marginal edge regions of the bottom sandwich panel 12b wherein the bent portions 20 of the two side sandwich panels 12s extend along an entire length of each respective side sandwich panel 12s. The front, rear and side sandwich panels 12f, 12r, 12s further include protruding portions 20 on the top edges of each respective front, rear and side sandwich panels 12f, 12r, 12s including bent portions 22 bent and folded over exposed top edges 26 of the cores 14 of each respective sandwich panels 12f, 12r, 12s to cap the core 14 and prevent infiltration therein. Finally, the front and rear sandwich panels 12f, 12r include protruding portions 20 located on side edges thereof and extending along an entire length of each front and rear sandwich panels 12f, 12r respectively and include bent portions 22 defining open edge spaces 24 sized to receive an adjacent side sandwich panel 12s positioned at 90° from the front and rear sandwich panels 12f, 12r respectively.

In yet another embodiment (not illustrated), the container body 11 can be made of front, rear and side sandwich panels 12f, 12r, 12s having a bent portion 22 on the bottom edges of the front, rear and side sandwich panels 12f, 12r, 12s defining open edge spaces 24 sized to receive the marginal edge regions of the bottom sandwich panel 12b as described above, protruding portions 20 on the top edges of the front, rear and side sandwich panels 12f, 12r, 12s including bent portions 22 bent and folded over exposed top edges 26 of the cores 14 of each respective sandwich panels 12f, 12r, 12s to cap the core 14 and substantially prevent infiltration therein, and protruding portions 20 on one of a right-side edge or a left-side edge of each respective front, rear and side sandwich panels 12f, 12r, 12s, including a bent portion 22 defining an open edge space 24 sized to receive an adjacent sandwich panel 12 positioned at 90° from each of the respective sandwich panel 12f, 12r, 12s, on the right-side or the left-side thereof.

In an alternative embodiment (not illustrated), the container body 11 can be made of made of a bottom sandwich panel 12b having bent portions 22 along the bottom front, rear and side edges defining open edge spaces 24 sized to receive the marginal edge regions of the front, rear and side sandwich panels 12f, 12r, 12s, wherein the bent portions 20 of the bottom sandwich panel 12b extend along an entire length of each respective side of the bottom sandwich panel 12b. The front, rear and side sandwich panels 12f, 12r, 12s further include protruding portions 20 on the top edges of each respective front, rear and side sandwich panels 12f, 12r, 12s including bent portions 22 bent and folded over exposed top edges 26 of the cores 14 of each respective sandwich panels 12f, 12r, 12s to cap the core 14 and prevent infiltration therein. Finally, the front and rear sandwich panels 12f, 12r include protruding portions 20 located on side edges thereof and extending along an entire length of each front and rear sandwich panels 12f, 12r respectively and include bent portions 22 defining open edge spaces 24 sized to receive an adjacent side sandwich panel 12s positioned at 90° from the front and rear sandwich panels 12f, 12r respectively.

Combinations of the above-embodiments can be foreseen.

As will be described in more details below, the assembled sandwich panels 12 defining the container body 11 are secured together with fasteners 44 inserted in the sandwich panels 12. Referring to FIG. 1, the container 10 also includes, in some implementations, a band 46 wrapped around container body 11 and securing the assembled front, rear and side sandwich panels 12f, 12r, 12s together. The band 46 can be an extruded metallic or plastic structure. The band 46 can provide additional structural rigidity to the container body 11.

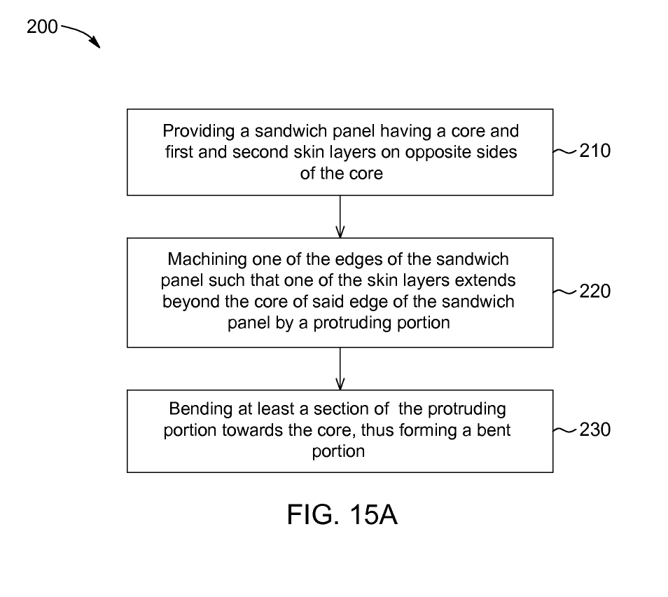

In some implementations, the bent portion 22 is formed by applying a linear source of heat to the protruding portion 20 and bending at least a section of the protruding portion 20 around the linear source of heat. Referring to FIG. 14, an example of an apparatus 30 including such a linear source of heat 32 is shown. The linear source of heat 32 can include any linear structure, such as a wire or a beam, which can apply heat to the protruding portion 20 in a linear manner. In addition, the linear source of heat 32 can also apply compressive pressure along the length of the linear source of heat 32 to enhance the bending around a bending axis B of the protruding portion 20 of one of the skin layers 16a, 16b that will become a bent portion 22. In an embodiment, the bending axis B extends substantially parallel to the edge 26 of the core 14. In some implementations, the skin layer 16a, 16b to be bent is heated by the linear source of heat 32 to a temperature above about 325° F. before bending around the bending axis B the protruding portion 20. In an alternative embodiment, one of the skin layers 16a, 16b to be bent is heated by the linear source of heat 32 to a temperature above about 350° F. In an embodiment, heat is applied for a period of at least 10 seconds before bending the protruding portion 20 and, in another embodiment, for a period of at least 15 seconds.

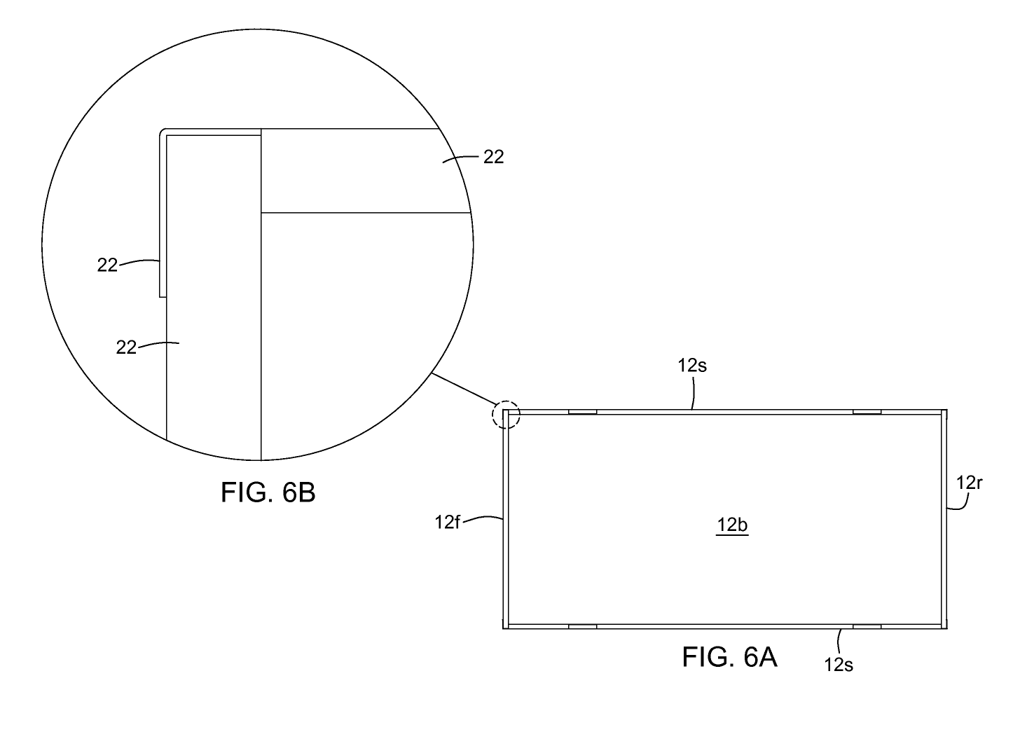

Referring to FIGS. 7A and 7B, the container 10 can include a removable top cover 40 engageable with the container body 11 and selectively configurable in a closed configuration for preventing access to the storage space and an open configuration allowing access to the storage space. The top cover 40 includes a sandwich panel 13 including a geometrical pattern structure core 15 defining hollow cells, and an outer and an inner skin layers 17a, 17b extending on opposite sides of the core 15. The sandwich panel 13 is divided into a top panel section 13b, two opposed side panel sections 13s, a front panel section 13f, and a rear panel section 13r. Folding channels 25 extend between each one of the side panel sections 13s, the front panel section 13f, and the rear panel section 13r and the top panel section 13b. More particularly, the top cover 40 includes folding channels 25 defined between the core 15 of the top panel section 13b and the core 15 of the respective one of the side, front, and rear panel sections 13s, 13f, 13r. Each one of the side, front, and rear panel sections 13s, 13f, 13r is thus hingedly connected to the top panel section 13b through the outer skin layer 17a. This hinged connection is better seen on FIG. 7A, wherein the thin arrows indicate how the side, front, and rear panel sections 13s, 13f, 13r can be bent in an assembled configuration using the same apparatus 30 as described above in reference to FIG. 14.

Still referring to FIG. 7A, the geometrical pattern structure core 15 and the inner skin layer 17b extends discontinuously along the top cover 40. The side, front, and rear panel sections 13s, 13f, 13r extend substantially perpendicular to the top panel section 13b in the assembled configuration of the top cover 40, as shown in FIG. 7B. In an embodiment, as shown in FIG. 7A, the folding channels 25 are free of the geometrical pattern structure core 15 and the inner skin layer 17b. In an embodiment, a width of the folding channels 25 substantially corresponds to a thickness of the sandwich panel 13. Still referring to FIG. 7A, sections of the outer skin layer 17b extending in the folding channels 25 are juxtaposed to a respective one of the edges of the core 15 of the top panel section 13b and cover the same in the assembled configuration of the top cover 40. In addition, in the embodiment shown, each one of the side, front, and rear panel sections 13s, 13f, 13r of the top cover 40 include a protruding portion 21 defined by the outer skin layer 17a extending beyond the core 15 along a respective edge extending substantially parallel to the respective one of the folding channel 25. As better illustrated in FIG. 7B, each one of the protruding portion 21 includes a bent portion 23 folded against and over the respective edge of the core 15 and covers the same.

Still referring to FIGS. 7A and 7B, the front and rear panel sections 13f, 13r extend along a width of the top panel section 13b and the two side panel sections 13s extend along a length of the top panel section 13b. The front and rear panel sections 13f, 13r extend substantially perpendicularly to the two side panel sections 13s. The core 15 and the inner skin layer 17b of either the front and rear panel sections 13f, 13r or the two side panel sections 13s are shorter than a corresponding one of the width and the length of the top panel section 13b along which the respective one of the panel sections extend. In the embodiment illustrated, the outer skin layer 17a of the front and rear panel sections 13f, 13r has substantially a same width than the width of the top panel section 13b and the outer skin layer 17a of the two side panel sections 13s has substantially a same length than the length of the top panel section 13b. Thereby, side protruding portions 21 of the outer skin 17a are defined along the edges of the respective one of the panel sections. The side protruding portions 21 are folded against the adjacent one of the other one of the front and rear panel sections 13f, 13r and the two side panel sections 13s, against the outer skin layer 17a thereof, in the assembled configuration of the top cover 40 as seen in FIG. 7B.

In some implementations, a sealing assembly (not shown) can be provided between the container body 11 and the top cover 40 to further prevent infiltrations when the container 10 is in the closed configuration. Referring to FIG. 1, in an embodiment, hardware components, such as handles, hooks, D-rings, wheels, hinges and locks, can be mounted to the sandwich panels 12 defining the container body 11. In the embodiment shown in FIG. 1, the container body 11 includes handles 52 mounted onto an end sandwich panel 12. The container 10 also includes hinges 42 pivotally engaging the top cover 40 with the container body 11. The hinges 42 can be mounted in recessed slots defined in at least one of the container body 11 and the top cover 40. The top cover 40 can therefore be selectively configurable in the closed configuration preventing access to the storage space and the open configuration allowing access to the storage space.

In an embodiment, the hardware components can be mounted through rivets (not illustrated). In an embodiment, the rivets extend only through one of the skin layers 16a, 16b, i.e. they do not extend through the other one of the skin layers 16a, 16b to substantially prevent liquid infiltration in the storage space. The head of the rivet is abutted against a first one of the skin layers 16a, 16b and the buck-tail of the rivet, i.e. the end opposite the head, is upset, or deformed, against the first one of the skin layers 16a, 16b inside the core 14, on the face opposed to the face against which the head is abutted. Thus, if a handle 52 is mounted on a first side of a sandwich panel 12 through at least one rivet, the handle 52 including the at least one rivet is invisible from a second side of the sandwich panel 12.

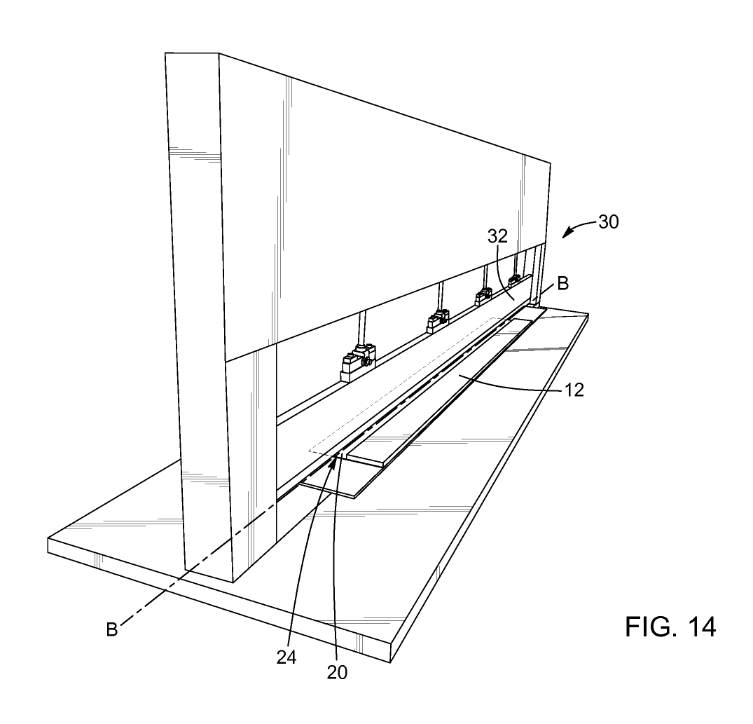

As shown in FIGS. 4 and 13, the container body 11 and the top cover 40 can further include fasteners 44 to secure the sandwich panel assemblies together. The fasteners 44 extend through the bent portions 22 of the sandwich panels 12 and the marginal edge region of the adjacent one of the sandwich panels 12 inserted in a respective one of the open edge spaces 24 for fastening the assembled sandwich panels 12 together, thus forming assembled sandwich panels 50. The fasteners 44 can be selected from the group comprising adhesives, rivets or a combination of adhesives and rivets, or any other equivalent type of mechanical fastener.

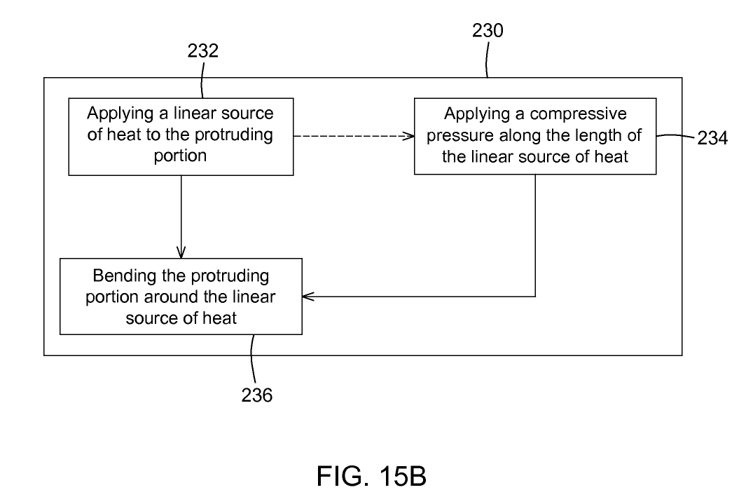

With reference to FIG. 15A, there is also provided a method 200 for manufacturing a sandwich panel 12. The method 200 comprises the following steps.

The first step of the method 200 involves providing a sandwich panel 12 having a geometrical pattern structure core 14 defining hollow cells and first and second skin layers 16a, 16b on opposite sides of the core 14 (210), as described above.

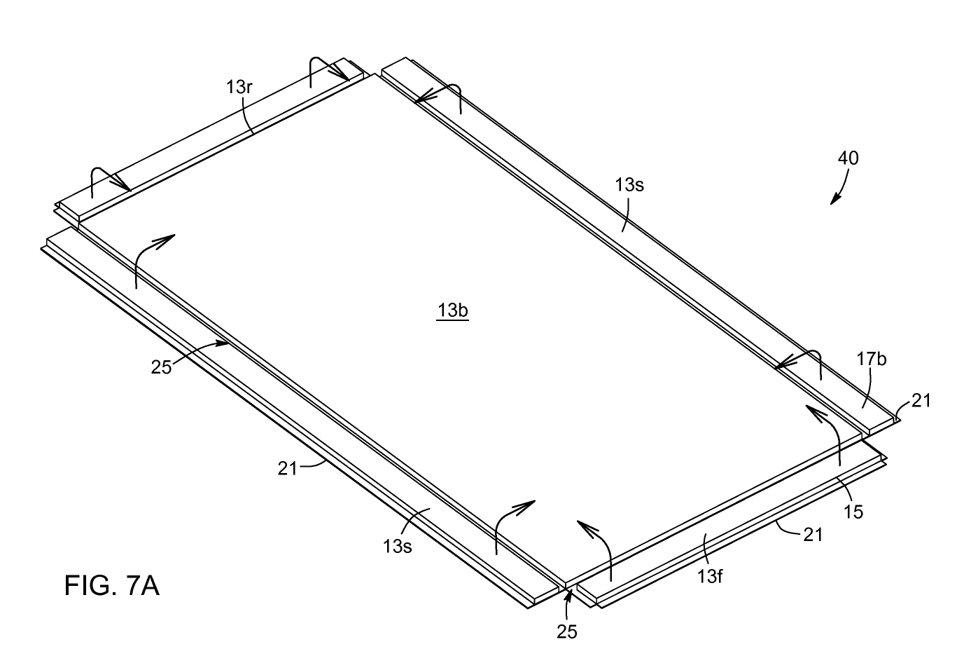

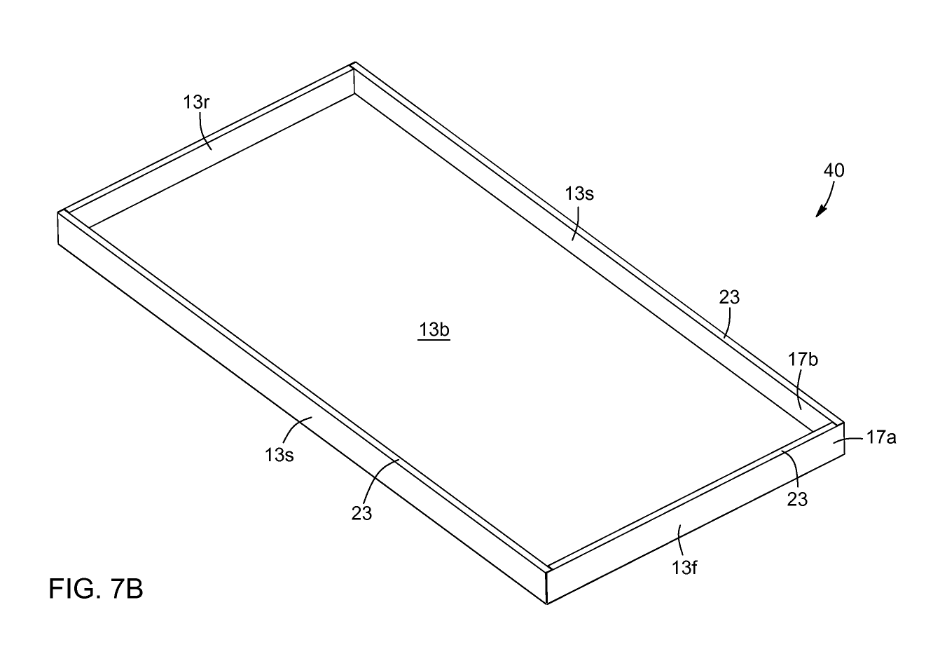

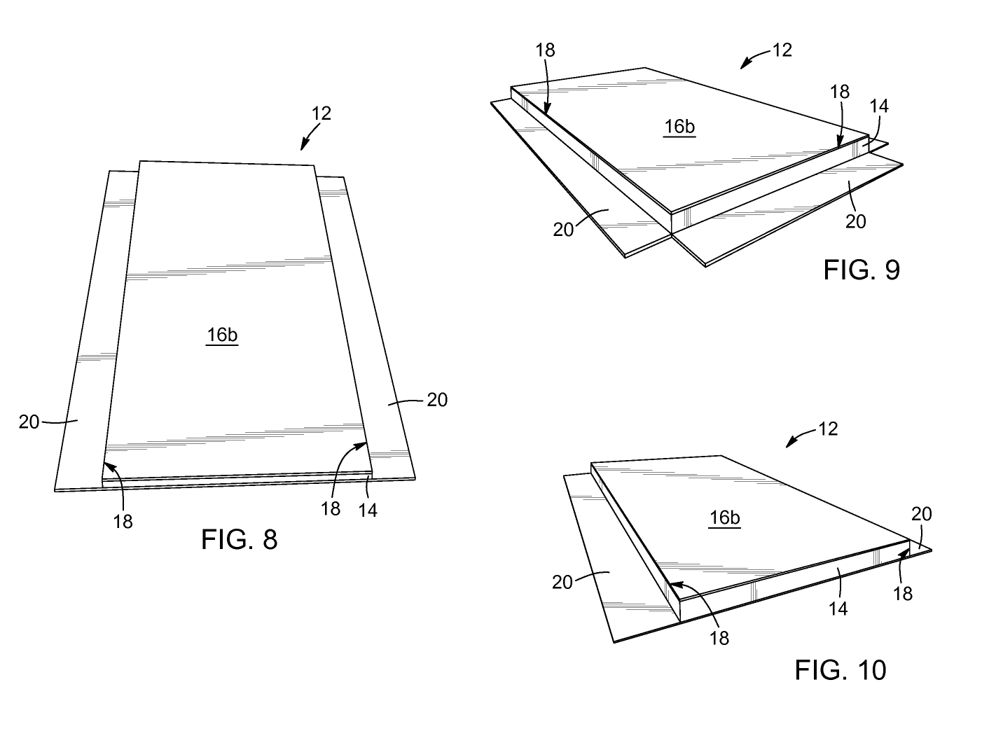

The next step of the method 200 involves machining at least one edge 18 of the sandwich panel 12 to define a protruding portion 20 including one of the skin layers 16a, 16b extending beyond the core 14 of the at least one edge 18 of the sandwich panel 12 (220). Different embodiments of the resulting sandwich panels can be seen in FIGS. 8 to 10. Referring to FIG. 8, there is shown a sandwich panel 12 wherein two protruding portions 20 extend along both longitudinal sides of the sandwich panel. Referring to FIG. 9, there is shown a sandwich panel 12 wherein protruding portions 20 extend along both longitudinal and lateral sides of the sandwich panel. Referring to FIG. 10, there is shown a sandwich panel 12 wherein two protruding portions having different widths extend along both longitudinal sides of the sandwich panel. In some implementations, the machining can be done for example by cutting away portions of the core 14 and of the other one of the skin layers 16a, 16b of the sandwich panel 12. In a non-limitative embodiment, the machining can be carried out by cutting successively several thin layers of one of the skin layers 16a, 16b and the core 14, by taking out the cut layers, and removing, for example by vacuuming, the material. In another non-limitative embodiment, the machining 220 can be carried out by cutting a slit (not illustrated) into the other one of the skin layers 16a, 16b and the core 14 and pulling off a section including the other one of the skin layers 16a, 16b and the core 14 and from the skin layer 16a, 16b including the protruding portion 20. The purpose of the machining step is to expose the protruding portion 20 of the skin layer by removing sections of the core 14 and of the other one of the skin layers 16a, 16b.

The final step of the method 200 involves bending at least a section of the protruding portion 20 towards the core 14, thus forming a bent portion 22 (230).

The bending step 230 of the method 200 includes, in an embodiment, bending at least a section of the protruding portion 20 along a bending axis B spaced-apart from the core 14 to define an open edge space 24 between the bent portion 22 and an edge of the core 14. As mentioned above, a width of the open edge space 24 can be determined based on the thickness of the sandwich panel 12. In accordance with the above description, in an embodiment, the bending of the protruding portion 20 can take place along a bending axis B that is adjacent to an edge of the core 14 in order for the bent portion 20 to be folded against and extending over the edge of the core 14 and covering the same.

Referring to FIG. 15B, in an alternative embodiment, the bending step 230 can include applying a linear source of heat 32 to the protruding portion 20 (232) and then bending at least a section of the protruding portion 20 around the linear source of heat 32 (236). In another alternative embodiment, the bending step 230 can include applying a linear source of heat 32 to the protruding portion 20 (232), applying a compressive pressure along the length of the linear source of heat 32 (234) and then bending at least a section of the protruding portion 20 around the linear source of heat 32 (236). As mentioned above, the bent portion 22 can be bent so as to define an open edge space 24 sized to receive an adjacent sandwich panel 12, i.e. the bent portion 22 is spaced-apart from the edge 26 of the core 14. Alternatively, the bent portion 22 can be juxtaposed to the exposed edge 26 of the core 14, thereby sheltering the exposed edge 26 of the core 14 from external elements and substantially sealing the core 14 against infiltration through the exposed edge 26.

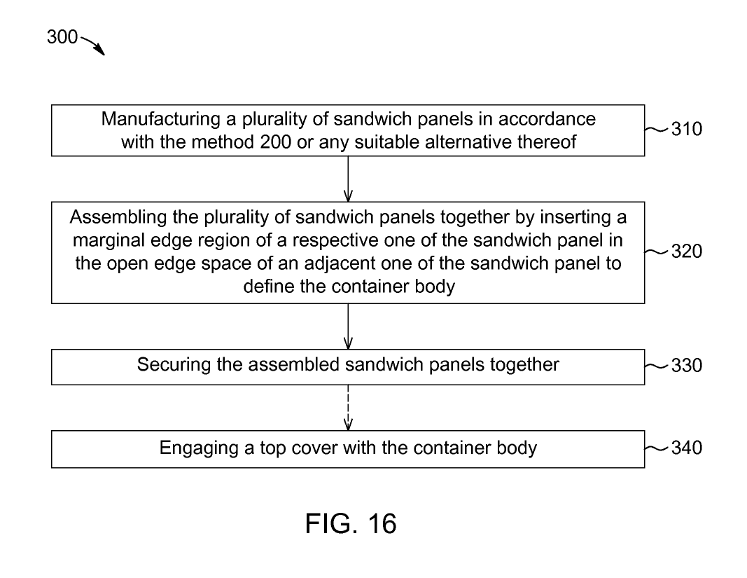

According to another aspect and with reference to FIG. 16, there is provided a method 300 for assembling a container body 11.

In some implementations, the method 300 first includes manufacturing a plurality of sandwich panels 12 in accordance with the above-described method 200 or any suitable alternative thereof (310).

Then, the next step of the method 300 involves assembling the plurality of sandwich panels 12 together into assembled sandwich panels 50 by inserting a marginal edge region of a respective one of the sandwich panel 12 in the open edge space 24 of an adjacent one of the sandwich panel 12 to define the container body 11 (320). In the embodiment shown in FIGS. 2A to 6B, the container body 11 has a front sandwich panel 12f, a rear sandwich panel 12r, two side sandwich panels 12s spaced-apart from one another, and a bottom sandwich panel 12b, with the bottom sandwich panel 12b having edges engaged with each one of the front, rear, and side sandwich panels 12f, 12r, 12s and each of the front and the rear sandwich panels 12f, 12r having side edges engaged with the two side sandwich panels 12s, thereby defining a storage space therebetween.

The final step of the method 300 involves securing the assembled sandwich panels 50 together (330). The securing of the assembled sandwich panels 50 can done using fasteners 44, as described above, and/or a band 46 wrapped around container body 11.

Optionally, in an embodiment, step 310 of the method 300 can further include the steps of machining top edges of the front, rear, and side sandwich panels 12f, 12r, 12s to define a protruding portion 20 including one of the skin layers 16a, 16b extending beyond the core 14 of the respective one of the top edges of the sandwich panel 12; and bending the protruding portion 20 along a bending axis B adjacent to a respective edge of the core 14. The bent portion 22 can be folded against and extending over the edge of the core 14 and covering the same.

In some implementations, the side edges of the side sandwich panels 12s include the protruding portions 20 defining the open edge spaces 24. A bottom edge of each of the front, rear, and side sandwich panels 12f, 12r, 12s include the protruding portions 20 defining the open edge spaces 24 and the assembling step 320 of the plurality of sandwich panels 12 together includes inserting marginal edge regions of the bottom sandwich panel 12b in a respective one of the open edge spaces 24 defined at the bottom edges of the front, rear, and side sandwich panels 12f, 12r, 12s and inserting the marginal edge regions of front and rear sandwich panels 12f, 12r in the open edge spaces 24 defined at the side edges of the side sandwich panels 12s.

In yet another embodiment, step 330 of the method 300 can further include inserting fasteners 44, as described above, through the bent portions 22 of the sandwich panels 12 and marginal edge region of the adjacent one of the sandwich panels 12 inserted in a respective one of the open edge spaces 24 for fastening the assembled sandwich panels 50 together.

Optionally, the method 300 further includes engaging a top cover 40 with the container body 11 (360). For instance, hinges operatively engaging the top cover 40 with the container body 11 can be used. The top cover 40 can be selectively configurable in a closed configuration preventing access to the storage space and an open configuration allowing access to the storage space.

It is to be noted that the method 300 and the optional steps described in accordance with the above description can be carried out in any suitable order.

In an embodiment, the method 300 and the optional steps described above can be carried out with sandwich panels 12 wherein the geometrical pattern structure core 14 is made of polypropylene and the skin layers 16a, 16b include at least one of fiberglass and polypropylene.

Of course, the scope of the following claims should not be limited by the preferred embodiments set forth in the examples, but should be given the broadest interpretation consistent with the description as a whole. Numerous modifications could be made to the above-described embodiments without departing from the scope of the claims, as apparent to a person skilled in the art. Furthermore, it is apparent that this invention can apply to many other uses.

1. A sandwich panel comprising:
a geometrical pattern structure core defining hollow cells; and
a first layer and a second skin layer extending on opposite sides of the core, one of the first and second skin layers having at least one protruding portion extending beyond the core along at least one edge of the sandwich panel, at least one of the protruding portion comprising a bent portion bent towards the core.

2. The sandwich panel according to claim 1, wherein the bent portion of at least one of the at least one protruding portion is spaced-apart from a respective edge of the core to define an open edge space therebetween, the open edge space having a width substantially corresponding to a thickness of the sandwich panel.

3. The sandwich panel according to claim 1, wherein the bent portion of at least one of the at least one protruding portion is folded against and over a respective edge of the core and covers the same.

4. The sandwich panel according to claim 1, wherein the geometrical pattern structure core is made of polypropylene and wherein the first and second skin layers comprise at least one of fiberglass and polypropylene.

5. A container comprising a plurality of sandwich panels as defined in claim 2 and assembled together by inserting a marginal edge region of a respective one of the sandwich panels in the open edge space of an adjacent one of the sandwich panels.

6. A container comprising: a container body including a plurality of sandwich panels assembled together to define a storage space;
the plurality of sandwich panels comprising: a geometrical pattern structure core defining hollow cells, and a first layer and a second skin layer extending on opposite sides of the core;
the plurality of sandwich panels comprising: front and rear sandwich panels, first and second side sandwich panels, and a bottom sandwich panel;
a plurality of the front and rear sandwich panels and the first and the second side sandwich panels comprising at least one protruding portion defined by one of the first and second skin layers extending beyond the core along a respective side edge and including a bent portion bent towards the core and spaced-apart from the respective edge of the core to define an open edge space therebetween, with a marginal edge region of an adjacent one of the front, rear, first side and second side sandwich panels being inserted in the open edge space to engage together the two adjacent ones of the sandwich panels; and
for each adjacent edges of the bottom sandwich panel with a respective one of the front, rear, first side and second side sandwich panels, one of the bottom sandwich panel and the respective one of the front, rear, first side and second side sandwich panels comprising at least one protruding portion defined by one of the first and second skin layers extending beyond the core along a respective edge and including a bent portion bent towards the core and spaced-apart from the respective edge of the core to define an open edge space therebetween, with a marginal edge region of the other one of the bottom sandwich panel and the respective one of the front, rear, first side and second side sandwich panels being inserted in the open edge space to engage together the two adjacent ones of the sandwich panels.

7. The container according to claim 6, wherein top edges of the front, rear, first side and second side sandwich panels comprise a protruding portion defined by one of the first and second skin layers extending beyond the core along a respective top edge and including a bent portion folded against and over the respective top edge of the core and covering the same.

8. The container according to claim 6, wherein the side edges of the first side and second side sandwich panels comprise the protruding portions defining the open edge spaces; and a bottom edge of each of the front, rear, first side and second side sandwich panels comprise the protruding portions defining the open edge spaces.

9. The container according to claim 6, wherein, in the container body, the geometrical pattern structure core of the plurality of sandwich panels defining the container body is unexposed, and wherein the container body further comprises fasteners extending through the bent portions of the sandwich panels and the marginal edge region of the adjacent one of the sandwich panels inserted in a respective one of the open edge spaces for fastening the assembled sandwich panels together.

10. The container according to claim 6, further comprising a top cover engageable with the container body and configurable in a closed configuration for preventing access to the storage space, wherein the top cover comprises a cover sandwich panel including a geometrical pattern structure core defining hollow cells, and an outer skin layer and an inner skin layer extending on opposite sides of the core, the cover sandwich panel comprising: a top panel section, two opposed side panel sections, a front panel section, and a rear panel section, the top cover comprising folding channels defined between the core of the top panel section and the core of the respective one of the side, front, and rear panel sections, each one of the side, front, and rear panel sections being hingedly connected to the top panel section through the outer skin layer, the geometrical pattern structure core and the inner skin layer extending discontinuously along the top cover, and the side, front, and rear panel sections extending substantially perpendicular to the top panel section in an assembled configuration of the top cover, and wherein the folding channels are free of the geometrical pattern structure core and the inner skin layer and a width of the folding channels substantially correspond to a thickness of the cover sandwich panel.

11. The container according to claim 10, wherein sections of the outer skin layer extending in the folding channels are juxtaposed to a respective one of the edges of the core of the top panel section and cover the same in the assembled configuration of the top cover, wherein each one of the side, front, and rear panel sections of the top cover comprises a protruding portion defined by the outer skin layer extending beyond the core along a respective edge extending substantially parallel to the respective one of the folding channel, each one of the protruding portion including a bent portion folded against and over the respective edge of the core and covering the same, and wherein the front and rear panel sections extend along a width of the top panel section and the two side panel sections extend along a length of the top panel section, and the core and the inner skin layer of one of the front and rear panel sections and the two side panel sections are shorter than a corresponding one of the width and the length of the top panel section along which the respective one of the panel sections extend, thereby defining side protruding portions of the outer skin layer, and the outer skin layer in the front and rear panel sections has substantially a same width than the width of the top panel section and the outer skin layer in the two side panel sections has substantially a same length than the length of the top panel section; and the side protruding portions being folded against the adjacent one of the other one of the front and rear panel sections and the two side panel sections, against the outer skin layer thereof, in the assembled configuration of the top cover.

12. The container according to claim 6, wherein the geometrical pattern structure core is made of polypropylene and the skin layers comprise at least one of fiberglass and polypropylene.

13. A method for manufacturing a sandwich panel, comprising:
providing a sandwich panel comprising:
a geometrical pattern structure core defining hollow cells; and
a first skin layer and a second skin layer on opposite sides of the core;
machining at least one edge of the sandwich panel to define a protruding portion including one of the first and second skin layers extending beyond the core along said at least one edge of the sandwich panel; and
bending at least a section of the protruding portion towards the core, thus forming a bent portion.

14. The method according to claim 13, wherein bending at least a section of the protruding portion comprises bending at least a section of the protruding portion along a bending axis spaced-apart from the core to define an open edge space between the bent portion and an edge of the core, the open edge space having a width substantially corresponding to a thickness of the sandwich panel.

15. The method according to claim 13, wherein bending at least a section of the protruding portion comprises bending at least a section of the protruding portion along a bending axis adjacent to an edge of the core, the bent portion being folded against and extending over the edge of the core and covering the same.

16. The method according to claim 13, wherein machining at least one of the edges of the sandwich panel comprises successively cutting a plurality of thin layers of the other one of the skin layers and the core to expose the skin layer including the protruding portion, and wherein machining at least one of the edges of the sandwich panel comprises cutting a slit into the other one of the skin layers and the core and pulling off a section including the other one of the skin layers and the core and from the skin layer including the protruding portion.

17. A method for assembling a container body, comprising:
manufacturing a plurality of sandwich panels in accordance with claim 14;
assembling the plurality of sandwich panels together by inserting a marginal edge region of a respective one of the sandwich panel in the open edge space of an adjacent one of the sandwich panel to define the container body having a front sandwich panel, a rear sandwich panel, two side sandwich panels spaced-apart from one another, and a bottom sandwich panel, with the bottom sandwich panel having edges engaged with each one of the front, rear, and side sandwich panels and each of the front and the rear sandwich panels having side edges engaged with the two side sandwich panels, thereby defining a storage space therebetween; and
securing the assembled sandwich panels together.

18. The method according to claim 17, further comprising: machining top edges of the front, rear, and side sandwich panels to define a protruding portion including one of the skin layers extending beyond the core of the respective one of the top edges of the sandwich panel; and bending at least a section of the protruding portion along a bending axis adjacent to a respective edge of the core, the bent portion being folded against and extending over the edge of the core and covering the same.

19. The method according to claim 17, wherein the side edges of the side sandwich panels comprise the protruding portions defining the open edge spaces; a bottom edge of each of the front, rear, and side sandwich panels comprise the protruding portions defining the open edge spaces; and wherein assembling the plurality of sandwich panels together comprises inserting marginal edge regions of the bottom sandwich panel in a respective one of the open edge spaces defined at the bottom edges of the front, rear, and side sandwich panels and inserting marginal edge regions of front and rear sandwich panels in the open edge spaces defined at the side edges of the side sandwich panels.

20. The method according to claim 17, further comprising inserting fasteners through the bent portions of the sandwich panels and marginal edge region of the adjacent one of the sandwich panels inserted in a respective one of the open edge spaces for fastening the assembled sandwich panels together.
